(19) United States
(12) Patent Application Publication
(10) Pub. No.: US 2006/0082657 A1
(43) Pub. Date: Apr. 20, 2006

(54) Digital camera improvements

(76) Inventor: Raymond Meier, New York, NY (US)

Correspondence Address: NOTARO AND MICHALOS, 100 DUTCH HILL ROAD, SUITE 110, ORANGEBURG, NY, 10962-2100, US

(21) Appl. No.: 10/967,929

(22) Filed: Oct. 19, 2004

(51) Int. Cl. H04N 5/228

(52) U.S. Cl. 348/208.7; 348/208.99

(57) ABSTRACT

A digital camera with a housing has a digital image device (ICD) that preferably has a special shape and a flat light sensing surface. A lens directs light to the light sensing surface and electronics are connected to the ICD for capturing image data. A memory stores the image data. An inclinometer in the housing detects an inclination angle of the housing and is used to correct for various distortions or otherwise modify the image data. The aspect ratio of the digital image can also be selected. The ICD is mounted on a yoke for pivoting about at least one axis passing through the ICD plane to correct focus by following the Scheimpflug Rule and/or by collecting focus and distance information for multiple points to create a focus point landscape used, for example, to tilt the ICD to the best focus solution for the image.

### FIELD AND BACKGROUND OF THE INVENTION

The present invention relates generally to the field of digital photography, and, in particular, to various new, useful and interrelated improvements for digital cameras.

The most pertinent patents found during the course of a search conducted in US patent class 348, subclasses 208.2, 208.3, 208.12, 219.1, 222.1, 231.3, 231.6, 239, 275, 311, 315, 340, 345, 351 and 374, were:

| U.S. Pat. No. | Inventor(s) |
|---|---|
| 4,467,361 | Ohno, et al. |
| 4,480,257 | Hill |
| 4,866,850 | Kelly, et al. |
| 4,988,200 | Cohen-Sabban |
| 5,453,784 | Krishnan, et al. |
| 5,752,088 | Desselle |
| 5,813,333 | Ohno |
| 5,897,223 | Tritchew, et al. |
| 5,900,909 | Parulski, et al. |
| 5,969,760 | Ernest, et al. |
| 6,072,529 | Mutze |
| 6,083,353 | Iexander |
| 6,201,574 | Martin |
| 6,237,235 | Feist, et al. |
| 6,304,284 | Dunton, et al. |
| 6,310,642 | Adair et al. |
| 6,351,720 | Hoshina, et al. |
| 6,366,323 | Shono |
| 6,406,941 | Nakamura |
| 6,466,275 | Honey, et al. |
| 6,537,208 | Konno |
| 6,538,691 | Macy, et al. |
| 6,574,561 | Alexander |
| 6,603,503 | Ribera et al. |
| 6,618,093 | Levy |
| 6,659,940 | Adler |
| 6,665,016 | Saitoh |
| 6,670,986 | Shoshan, et al. |
| 6,686,954 | Kitaguchi, et al. |
| 6,727,954 | Okada et al. |
| 6,734,914 | Nishimura et al. |
| 6,772,632 | Okada and |
| 6,781,622 | Sato et al. |

Relevant published US patent applications classified in the same classes and subclasses were: U.S. patent Publication 2004/0017506 A1 to Livingston disclosing an orientation sensor for a digital camera comprising gravity sensitive switches such as mercury-filled switches and a pair of contacts; and U.S. patent Publication 2003/0063200 A1 to Isoyama disclosing an inclination sensor, wherein the detected inclination is saved to a memory card. During photographing, JPEG data corresponding to the object image is recorded onto a memory card in a file format. At that time, the detection result information indicative of the detection result of the inclination sensor is read and stored on the same image file.

Relevant patents may also include patents assigned to photographic equipment companies such as Sinar, Hasselblad, Leica, Rollei, Mamiya, Contax, Canon, and Nikon.

An assignee search for patents issued to these companies uncovered U.S. Pat. No. 6,734,914 to Nishimura et al. (assigned to Canon Kabushiki Kaisha).

U.S. Pat. No. 6,727,954 to Okada et al. (Okada '954) discloses a rotating image pickup element. The image pickup element comprises a capsule-shaped unit main body in which opposite ends of a cylinder are covered by semispherical surfaces. A round window exposes a taking lens inside the unit main body on a center axis, and an image pickup device having a CCD arranged behind the taking lens. A U-shaped support frame pivotally supports the unit main body along a vertical direction and an L-shaped support frame pivotally supports the unit main body along a horizontal direction. A driving member rotates the main body up, down, left and right. Position detecting members are also provided for detecting the rotational position of the unit main body in the vertical and horizontal planes. The position detecting members comprise a magnetic head, an arcuate magnetic scale and a position detecting circuit.

Although Okada '954 discloses a rotating unit main body containing a CCD, a driving member for rotating the unit main body, and position detecting magnetic and circuit means, it fails to teach a round CCD mounted in a dual axis yoke and an inclinometer.

U.S. Pat. No. 6,072,529 to Mutze discloses an electronic camera comprising an image sensor secured in a holding device mounted on supports for axial, horizontal and vertical displacements to fulfill the Scheimpflug condition. Movement of the image sensor is produced electromechanically.

This patent, however, only discloses a rectangular CCD and fails to teach or suggest a round CCD or an inclinometer.

U.S. Pat. No. 6,686,954 to Kitaguchi et al. discloses a digital camera deviation correction apparatus comprising a rotation detection unit which detects the quantity of rotation of the digital camera and a CCD. The rotation detecting device may be a set of acceleration sensors and magnetic sensors, or alternatively, gyros. A position angle calculating unit calculates a change of a positional angle of the CCD based on the rotation quantity detected by the rotation detecting unit. A drive control circuit drives a displacement transmitting element for moving the CCD to correct deviation as a result of rotation of the camera and CCD. The CCD can be rotated about the x and y axis via an L-shaped support and a motor.

U.S. Pat. No. 5,453,784 to Krishnan discloses an imaging apparatus comprising an imaging array such as a CCD array mounted on a rotation platform with two rotational degrees of freedom and pivotally controllable with respect to the optical axis of the lens. Rotation can be accomplished by a stepper motor.

U.S. Pat. No. 6,734,914 to Nishimura et al. teaches an image recording unit for a camera comprising a CCD mounted support means for rotatably supporting the image recording unit main body. A frictional driving source drives the image recording unit in arbitrary directions and comprises electromechanical energy conversion elements which generate a traveling wave by a supply of different wave signals. This patent does not teach a motor driven dual axis yoke.

U.S. Pat. No. 5,969,760 to Ernest, et al. discloses an electronic still camera comprising mechanically adjustable CCD for affecting focus. The camera uses a ranging system to determine a distance to an object. The camera has a micro processor which determines the proper location of the focal plane based on the measured distance of the focal plane and signals a motor and an actuation device to mechanically adjust the location of the sensor with respect to the lens. Ernest, et al. does not disclose a pivoting CCD.

U.S. Pat. No. 6,537,208 to Konno similarly discloses a movable solid state image pickup for an endoscope.

Round or circular solid state imaging elements (e.g. CCDs) are disclosed in U.S. Pat. No. 4,988,200 to Cohen-Sabban (see col. 5, lines 1-4), U.S. Pat. No. 4,467,361 to Ohno et al. (see FIG. 4, element 35A), U.S. Pat. No. 4,480,257 to Hill (see col. 1, lines 9-11; FIG. 4), U.S. Pat. No. 5,813,333 to Ohno (Ohno '333) (see col. 7, line 63), U.S. Pat. No. 6,310,642 to Adair et al. (col. 7, lines 1-4; FIG. 1b, element 40′), U.S. Pat. No. 6,659,940 to Adler (see its prior art discussion), and U.S. Pat. No. 6,406,941 to Nakamura (see FIG. 7). However, only Ohno '333 and Nakamura '941 disclose a camera having a round solid state imaging element. Furthermore, none of these patents teach or suggest use of a round solid state imaging element in combination with a fully operational and self-contained digital camera, for capturing an image to a high resolution data file so that various other useful effects and capacities can be realized, such as a selectable aspect ratio having maximum lens coverage and unwanted areas removed.

U.S. Pat. No. 6,201,574 to Martin and U.S. Pat. No. 6,603,503 to Ribera et al. disclose a spherical CCD.

Inclinometers are known from U.S. Pat. No. 6,574,561 to Alexander, U.S. Pat. No. 6,466,275 to Honey et al., U.S. Pat. No. 6,351,720 to Hoshina et al., U.S. Pat. No. 6,237,235 to Feist et al., U.S. Pat. No. 6,083,353 to Alexander, U.S. Pat. No. 5,897,223 to Tritchew et al., and U.S. Pat. No. 4,866,850 to Kelly et al., some disclosed for use with cameras in general, or in combination with digital cameras.

U.S. Pat. No. 6,772,632 to Okada discloses an acceleration sensor which can be used as a clinometer in digital cameras.

Patents were also uncovered which teach devices in which orientation information is stored or saved. U.S. Pat. No. 6,304,284 to Dunton et al. discloses a camera system for generating panoramic images in which orientation information is recorded in memory. A motion sensor or accelerometer is used to detect the orientation. A processor reconstructs a panoramic image from recorded images using the recorded orientation information.

The remaining patents in the above list disclose other digital camera enhancements which are distinguishable from the present invention and which have been cited for general reference.

The inventor here is a professional photographer and has discovered several deficiencies in currently known digital cameras which are addresses by the invention disclosed herein.

### SUMMARY OF THE INVENTION

It is an object of the present invention to provide various improvements for the digital camera. All of the proposed improvements relate to image control and correction. The invention relies on various new combinations of proven optical laws and techniques and new methods for digitally reading and processing camera parameters and editing digital image outputs. The inventor has found the new advancements in technology allow for classical image control techniques to be modified in new ways and used in conjunction with digital input and image correction methods to produce a desired output not possible if relying on classical film camera methods alone, and not currently know or used in digital cameras or digital photography.

The digital camera according to one embodiment of the invention comprises a round Image Capture Device (ICD) mounted in a dual axis yoke for facilitating pivoting of the ICD about its horizontal axis. The ICD of the present invention, whether round, rectangular or otherwise shaped, may be a Charge Coupled Devise (CCD) or any one of a variety of light sensing, usually semiconductor-bases devices that are capable of being read using digital technology and are of presently know type, or future construction.

The yoke pivots within the camera back housing about its vertical axis. Each axis is independently controlled by a separate digital motor. The digital camera also comprises a digital inclinometer which continuously samples the lens angle with respect to the horizontal axis and then outputs information to an onboard computer or electronic circuit means or image modifying means, which send a digital signal to the digital motor for controlling the axis of the dual axis yoke.

In use, the round ICD captures the image to a high resolution data file and permits selection of an aspect ratio that includes maximum lens coverage and/or removal of unwanted areas. The attached data file also incorporates information on the camera roll angle measured by the digital inclinometer. Once this data is saved, it can be corrected digitally. Pivoting the ICD in relation to the lens plane adjusts the plane of sharp focus. Convergence results when the ICD plane is adjusted away from a plane parallel to the lens plane. A pre-defined convergence correction curve as a function of the lens angle can be used to correct the resulting convergence from the adjustment of the plane of sharp focus.

Other new and useful aspects of the invention, however do not require a round ICD but may use conventional rectangular ICDs or specially shaped ICDs such as cross-shaped ICDs or oval ICDs or even polygonal ICDs of at least eight sides which therefore mimic a circular ICD.

Accordingly, another object of the present invention is to provide a digital camera comprising a housing enclosing a volume, a digital image capture device (ICD) in the housing, the ICD having a round, circular, oval, polygon (with at least about eight sides) or cross-shaped and flat light sensing surface laying in an ICD plane, a lens connected to the housing for directing light from an actual image plane outside the housing, onto the light sensing surface of the ICD, electronic means connected to the ICD for capturing image data from the ICD corresponding to the light from the actual image to create a digital image and memory means connected to the electronic means for storing the image data.

Another object of the invention is to provide a digital camera with an inclinometer in the housing for detecting an inclination angle of the housing about at least one horizontal axis, the inclinometer being connected to the electronic means for use in correcting at least one aspect of the digital image.

A still further object of the invention is to provide a digital camera including aspect ratio control means connected to the electronic means for processing data from a selected area of the light sensing surface having one of a plurality of aspect ratios and for masking a remaining area of the light sensing surface.

A digital camera is also provided which includes correcting means for correcting at least one aspect of the digital image connected to the electronic means and a viewfinder connected to the electronic means for receiving the digital image in a corrected and in an uncorrected form so the photographer can see the actual unmodified image or the image as it would appear after it has been subjected to correction or modification according to the present invention. The camera may have at least one of pitch and/or roll gimbal or yoke means in the housing for mounting the ICD and a mechanical focus plane control or drive for controlling at least one of the pitch and roll angle of the ICD with respect to the housing to correct the image plane for focus (according to the so-called Scheimpflug Rule for example).

A digital camera of the invention may also include a manual focus and/or auto-focus means of know design that can be used to determining a distance between the lens and a selected point or a matrix of points on the actual image plane.

A focus point landscape can be created with the ICD divided into many points and with one focusing scan (that is, the ICD cycled through its full range of motion once) so all points are focused at the best position of the ICD. Then the ICD is tilted to the best angle for the best average focus.

A further object of the invention is to provide an improved digital camera with one or more advantages over current digital cameras and one which is simple in design and rugged in construction.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a vertical elevation of a round or circular Image Capture Device (ICD) according to one aspect of the present invention, illustrating the full lens coverage possible with various standard aspect ratios created by masking unwanted areas superimposed on the ICD;

FIG. 2 is a composite illustrating certain advantages of the present invention;

FIG. 3 is a composite illustrating how the present invention is capable of switching between vertical (image E) and horizontal (image F) panoramic aspect ratios without physically turning the camera body;

FIG. 4 is a user defined correction curve plotting the angle between the lens plane and vertical in degrees, against a convergence correction factor in percent and showing how the convergence correction can be a function of lens angle predefined by the photographer;

FIG. 5 is a composite illustrating the dynamics between Plane of Sharp Focus (PSF), the Building Face (BF) of an image and digital convergence correction;

FIG. 6 is a diagram illustrating the so-called Scheimpflug Rule of photography;

FIG. 7 is a perspective view with underlying areas visible, of a digital camera of the present invention;

FIG. 8 is a composite of four side elevational views of the digital camera of FIG. 7, showing various positions of the ICD thereof;

FIG. 9 is a perspective view similar to FIG. 7 of a further embodiment of the invention; and

FIG. 10 is a composite view similar to FIG. 8 of the embodiment of FIG. 9.

### DESCRIPTION OF THE PREFERRED EMBODIMENTS

In order to simplify this disclosure, the following definitions are used but may be given broader meaning as would be understood by those skilled in the art of photography in general, and digital photography specifically, if any of these terms are used in the claims:
Convergence: Image distortion, usually seen as converging of parallel lines, created by not having the film plane (ICD plane) parallel to the plane of the subject of focus (the actual image plane).
Data File: A file attached to or part of the High Resolution Image File that contains information about specific camera settings and parameters at the time the picture was taken.
Digital Motor: An extremely accurate positioning motor connected to one of the axis on the Dual Axis Yoke. Its function is to rotate the Image Capture Device or ICD to a precise angle.
Dual Axis Yoke: A fixture that supports the ICD and allows the ICD plane to be rotated about the vertically and horizontal (or any other) axis independently. The design is such that the distance between a point on the lens plane at the center of the lens and a point on the ICD plane at the center of the ICD will remain constant independent of a change in ICD angle.

High Resolution
Image File: The image file captured by the ICD when the camera shutter is released. A round ICD will produce a round image. This is ideal for all digital correction processes of the present invention because all information captured by the lens is retained.

Image Capture
Device Plane: The light sensing surface or plane where the lens image is recorded. Currently, most digital cameras use a Charge Coupling Device (CCD) to record the image. In traditional film cameras the film was mounted to this plane.
Lens Coverage: Size of the total image circle projected by the lens.
Pitch Inclinometer: An instrument used to measure and record the camera pitch angle. Output from this instrument is used to adjust the ICD plane angle when setting the Plane of Sharp Focus

Plane of Sharp Focus
(Focus Plane or PSF): A plane in space, such as the actual image plane to be recorded. When viewed through the lens, everything that falls on this plane will be in focus. This plane can be moved toward and away from the lens by focusing the camera (changing the distance between the lens and film or ICD planes). The angle of the plane can be changed by tilting the camera angle, lens angle or film plane angle. The position and orientation of this plane is given by the Scheimpflug rule (see The Camera by Ansel Adams).
Roll Inclinometer: An instrument used to measure and record the camera roll angle. Output from this instrument is used to correct the Viewfinder Image in real time. It is also saved in the Data File and used to correct camera roll on the High Resolution Image File.
Viewfinder Image: A low resolution image that is output to a display. This image is used by the photographer to view composition and adjust focus before taking a picture.
Vignetting: This occurs when the lens of a view camera is swung, tilted, or slid and part of the film falls outside of the lens coverage and does not get exposed (see the Ansel Adams reference).

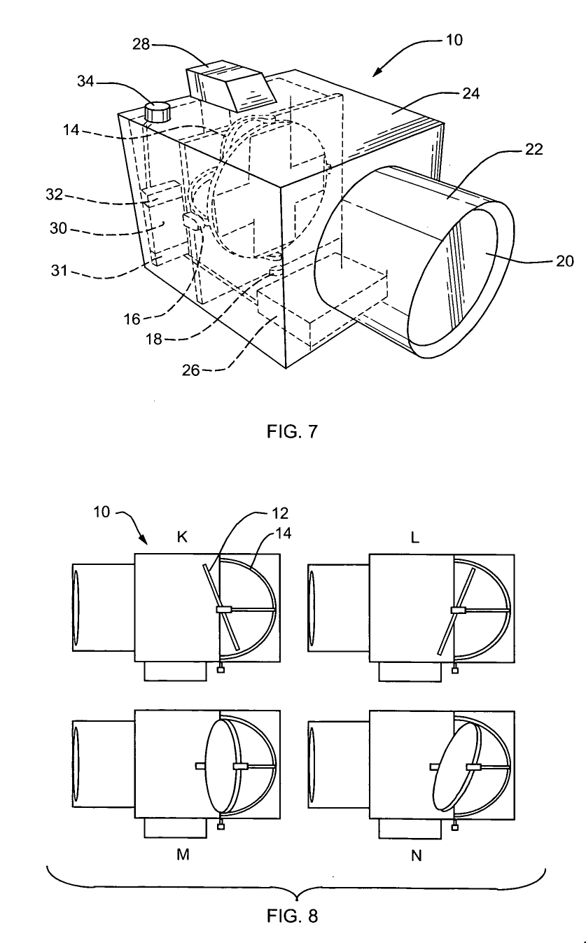

Referring now to the drawings, in which like reference numerals are used to refer to the same or similar elements, FIG. 7 illustrates the improved digital camera 10 of the present invention which will now be described in greater detail after these additional consideration.

General Design Guidelines:

1) Traditional guidelines of view camera photography state that convergence control (the control of perspective and image distortion) is accomplished by tilting the film plane while controlling of the Focus Plane (PSF) is accomplished by tilting the lens plane. Tilting the lens plane does not affect convergence but it does affect focus settings and can cause vignetting. Therefore, the traditional method for attaining the desired amount of convergence control, Focus Plane angle, and proper focusing range is a time consuming process requiring tilts at the lens and film plane along with a fundamental understanding of the Sheimpflug Rule (again see the Ansel Adams reference).

New technologies for camera position sensing and digital image processing used in the following design allow for all convergence corrections to be performed digitally. Current technology allows image distortion to be corrected digitally therefore all adjustments to the Focus Plane can be made solely by tilting the Image Capture Device (ICD) Plane (which replaces the film plane in digital cameras). By keeping the lens plane fixed, the camera design remains simpler, vignetting is not an issue and camera focus remains independent of the ICD Plane angle. The convergence caused by tilting the ICD is then corrected digitally after the picture has been taken. The camera sensors used in the following design makes it possible for correction parameters to be recorded with the image file and used to correct optical convergence automatically.

2) All rotational, convergence and perspective corrections and image cropping are performed digitally by applying correction parameters to a High Resolution Image File. The correction parameters can be saved within the High Resolution Image File or in a corresponding Data File.

3) A digital viewfinder shown at 28 in FIG. 7, is used to preview the photograph. The viewfinder displays a low resolution image in one of two modes: uncorrected or corrected. In Uncorrected Mode, the image is displayed exactly as if it were viewed directly through the lens, e.g. quadrant G in FIG. 5. In Corrected Mode the image is displayed as a preview of what the High Resolution Image File will look like after all correction parameters have been applied, e.g. quadrant J in FIG. 5.

Inventions/Improvements:

Round Image Capture Device (ICD)

A round ICD shown at 12 in FIGS. 7 and 8, is preferably used to capture the full Lens Coverage to a High Resolution Image File. Image aspect ratio is applied to the file by digitally masking out unwanted areas which will be more fully explained in connection with FIG. 2. Other ICD shapes can also be used with the aspect ratio selection feature of the present invention.

1) A round ICD is used to record the full lens coverage. The High Resolution Image File is created using the full lens coverage. An attached data file includes information on the aspect ratio selection for that image. This full coverage image can be captured using known digital camera circuits 30 in FIG. 7 which are electronically connected to ICD 12, and is stored as the High Resolution Image File in a memory section 32 of the circuit. According to the invention, the high resolution image file is modified in various unique ways using image modifying circuits or means 31 connected to the circuits 30 and memory 32.

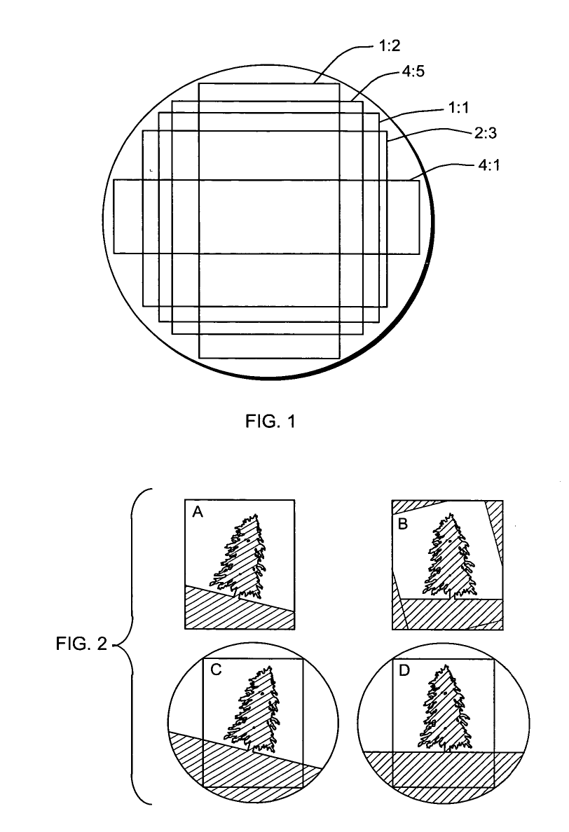

2) All standard vertical and horizontal aspect ratios are possible by masking the circular High Resolution Image File. In this way, any aspect ratio selected will include the maximum amount of lens coverage (see FIG. 1 for some of the standard aspect ratios which might be selected). An aspect ratio selector 34 and appropriate software, firmware or hardware in circuits 30 are provided for this purpose.

3) The digital viewfinder 28 displays the desired composition in the user-selected aspect ratio.

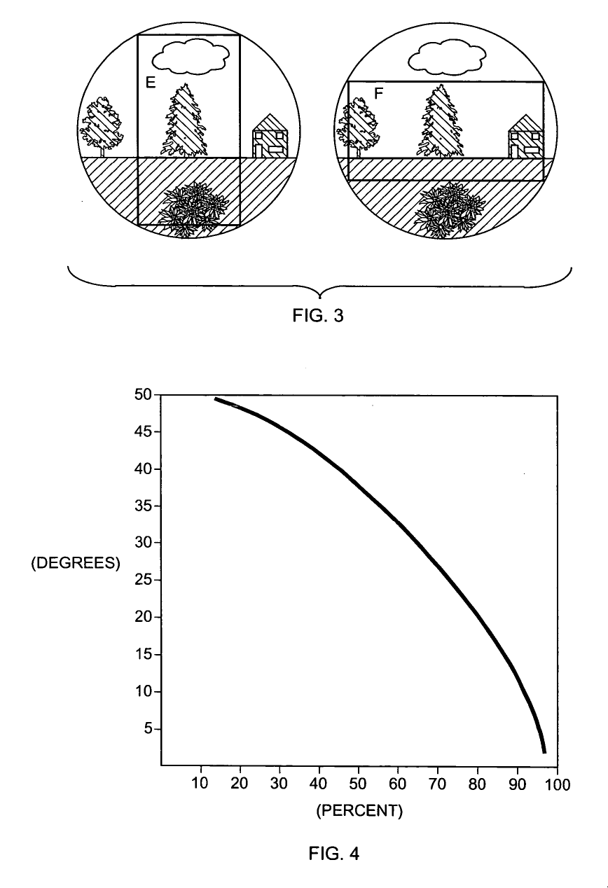

4) Since image formats are selected digitally, there is never a need to rotate the camera body 24. Also, it is possible to select a different aspect ratio after the picture has been taken without losing any lens coverage as will be explained in connection with FIG. 3.

5) Circular image capture allows for rotational correction without the problem of unwanted “corner cropping” (see FIG. 2). Unwanted areas of the round image file are permanently removed after all image corrections have been made to save storage size for the final digital image file.

Digital Camera Roll Correction:

A Digital Inclinometer 26 in FIG. 7, is used to detect the amount of camera roll about the horizontal axis passing through the center of lens 20 and ICD 12, when an image is taken. Digital correction is then applied to the High Resolution Image File.

1) Digital Roll Inclinometer 26 (e.g. an AccuStar® II/DAS 20, Dual Axis Clinometer and FIG. 7) continuously samples camera roll.

2) Rotational image correction is applied to the digital viewfinder image in real time. In Corrected Mode the viewfinder image always appears level regardless of camera roll. The viewfinder 28 shows an exact preview of how the High Resolution Image File will appear after correction.

3) The High Resolution Image File is captured with the round ICD using the full lens coverage. An attached or separate but associated Data File includes information on the camera roll angle at the time the picture was taken. Digital image rotation is used to correct the High Resolution Image File (FIG. 2). The amount of rotational correction is given by the roll inclinometer reading stored in the corresponding Data File in memory 32.

Mechanical Focus Plane Control with Digital Convergence: Correction

It is possible to adjust the Plane of Sharp Focus by tilting the ICD plane in relation to the lens plane. This adjustment causes convergence of parallel lines which can be corrected digitally.

1) The photographer selects whether the Plane of Sharp Focus will remain vertical, or, in rare cases such as for aerial photography, horizontal. Another possibility within the present invention is to provide the camera with a view screen that is pressure sensitive and to allow the photographer to manually select three desired points on the image displayed on the view screen. The ICD is then moved through a focus cycle and the three selected points are used to determine the final best tilt angle for the ICD.

2) Adjusting the angle of the Plane of Sharp Focus is accomplished by digitally controlling the ICD plane angle using horizontal and/or vertical motors 16, 18 to drive a yoke. The ICD 12 is mounted in a Dual Axis Yoke 14 which carry motors 16, 18. It is noted that the term yoke or gimbal as used here is meant to include a mounting mechanism that can pivot the ICD or its holder about at least one axis that is generally transverse to the axis passing through the centers of the ICD and the camera lens. This transverse axis may be vertical or horizontal or may be at 45 degrees or at any other angle to the vertical or horizontal. The only requirement is that the ICD can be pivoted, rotated or tilted with respect to the digital camera body as will become clearer in the following. In the preferred embodiment illustrated here, the ICD pivots in the yoke about its horizontal axis via motor 16. The yoke pivots within the camera back housing about its vertical axis via motor 18 (FIG. 7). Each axis is independently controlled by a digital motor controller in circuits 30. One motor rotates the plane about the vertical axis. The other motor rotates the plane about the horizontal axis (see FIG. 8 for example of the resulting motion).

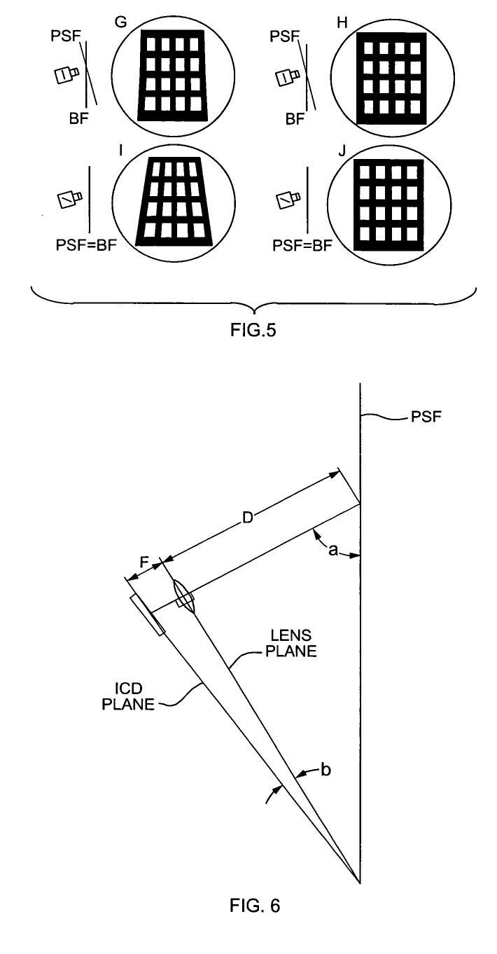

3) The lens angle from horizontal can be calculated automatically by a Pitch Inclinometer which is also in inclinometer 26. The inclinometer outputs information to an onboard computer in circuits 30, which sends a signal to the Digital Motor that controls the horizontal axis of the Dual Axis Yoke to rotate the ICD plane in relation to the lens plane (FIG. 7). The angle between these planes defines the Plane of Sharp Focus and can be calculated using a formula which will be explained in connection with FIG. 6. The angle of the Plane of Sharp Focus is governed by the Sheimpflug Rule (see the Ansel Adams reference).

4) Optionally, distance sensing means such as the know through-the-lens auto-focus method is used to determine the distance between the camera lens and multiple points in the frame or actual image plane being viewed. This data is then processed by the onboard computer to determine the best ICD plane angle for keeping all objects in focus. Such auto-focus method involves selecting two adjacent groups of pixels on the ICD and moving the lens through one or more focus cycles. When maximum contrast between the two pixel groups is detected, the lens position is assumed to be at the point of best focus since at the point the sharpest focus would result in the maximum contrast. Since the distance between the ICD and the lens is known, and the focal length of the lens is know, a simple calculation performed in the circuits of the camera will give the distance to the actual image.

By testing multiple points across the actual image plane being viewed, in a rectilinear matrix for example, a Focus Landscape can be created that identifies and stores the focus distance for each point in memory 32. This focus landscape can be used for various purposes, such as calculating the best tilt and roll angle for the ICD 12 using yoke 14 and motors 16, 18 for best or average focus of the frame. An auto-average function can be stored in the circuits 30 for achieving this best positioning for ICD 12.

5) When the lens plane and ICD plane are moved from parallel, optical convergence is introduced. Parallel lines appear to converge. The photographer can select the amount of convergence correction desired. One such method is to predefine a convergence correction curve as a function of lens angle (see FIGS. 4 and 5). The camera will then, in real time, digitally correct for convergence in the View Finder Image. When the picture is taken, a Convergence Correction Factor is saved in the Data File and then applied to the High Resolution Image File.

FIG. 1 shows, in a vertical elevational view, a circular Image Capture Device or ICD of the present invention with a number of aspect ratios that are possible according to the present invention, including but not limited to the standard aspect ratios of: 1:2—Panoramic Vertical; 4:5—Large Format; 1:1—Square; 2:3—35 mm and 4:1—Panoramic Horizontal. In this regard it is noted that statistically the best aspect ratio for a horizontal image is 2:3 or the hardware aspect ratio for 35 mm cameras which are ergonomically designed for horizontal images. About 75% of all images taken, however, are vertical so that most of the time the 35 mm camera is being held at the wrong orientation for its design, namely vertically or sideways. Further, the best aspect ratio for a vertical image is not 3:2 (as provided by the hardware-dictated, side-ways held 35 mm or usual digital camera) but is 4:3, which is not available at all in cameras of known design. The software solution of the present invention thus not only avoids having to turn the camera body, but its flexibility allows for the best possible aspect ratio for any image orientation.

FIG. 2 illustrates certain advantages of the present invention where the upper left quadrant A shows a picture recorded by a rectangular ICD at an angle from the horizontal, the roll angle being recorded in a data file; the upper right quadrant B shows the picture where digital roll correction is applied to the image file but corner cropping affects the rectangular image when it is rotated; the lower left quadrant C illustrates a picture recorded by a circular ICD at an angle from the horizontal and the angle of roll recorded in a data file; and the lower right quadrant D shows the picture with digital roll correction applied and no corner cropping because of the full lens coverage possible with an image file that is round.

In FIG. 3, the left image E is a vertical composition including the center tree, clouds and flowers. The right image F is a horizontal panoramic composition including both trees and the house. Full lens capture allows final composition decisions to be made after the image has been taken without losing lens coverage. Thus, the present invention with its capacity to switch between vertical (image E) and horizontal (image F) panoramic, or any other aspect ratio, without physically turning the camera body, gives the photographer the option to choose a different aspect ratio or image composition after the picture has been taken without losing lens coverage, all portions of the image bounded by any rectangular box within the round ICD being part of the final composition.

FIG. 4 shows the convergence correction curve which can be a function of lens angle predefined by the photographer.

FIG. 5 shows views on the ICD and visible through the viewfinder of a digital camera of the present invention, where the upper left quadrant G is with no ICD rotation, the upper right quadrant H is with no ICD rotation but with digital correction, the lower left quadrant I is with the ICD rotated about the horizontal axis, and J is with ICD Rotation and with digital correction.

In FIG. 5, quadrant G shows the Plane of Sharp Focus (PSF) parallel to the lens plane. The Building Face (BF) is only in focus along a horizontal line directly in front of lens. Parallel lines show slight convergence reflecting normal perspective. Quadrant H shows the image with camera settings the same as for quadrant G but with 100% digital convergence correction so that the converging lines become parallel. The image, however, remains out of focus on the top and bottom. In quadrant I of FIG. 5, the PSF aligns with the building face BF and the parallel line convergence becomes exaggerated. In quadrant J with 100% digital convergence correction applied to the image of quadrant H, lens and ICD angles are recorded and saved in the Data File. This information is used to perform digital convergence correction.

Referring to FIG. 6, the Scheimpflug Rule states that the Lens Plane, film plane in a camera but the ICD Plane for the present invention, and the Plane of Sharp Focus or PSF, must all converge on the same line. The angle b between the Lens Plane and the ICD Plane can be calculated as follows:
b=ArcTan(F/D*Tan(a));

where D is the distance between the center of the lens and a point in sharp focus directly in front of the lens (which can be given using the auto- or manual focus method as distance sensing means for the invention); F is the distance between the Lens Plane and a point directly in the center of the ICD (a know dimension of the camera); a is the angle between the Lens plane and the PSF (which can be supplied by the inclinometer 26); and b is the angle between the Lens Plane and the ICD plane (which can be supplied by knowing the yoke 14 tilt position).

Turning now to FIGS. 7 and 8, digital camera 10 contains ICD 12, e.g. a CCD, that is preferably round but may be a regular or irregular polygon of about eight or more sides, a cross, an oval or ellipse or other shape.

ICD 12 is mounted for pivoting on the yoke 14, about a horizontal axis via the horizontal digital motor 16 and about a vertical axis via the vertical digital motor 18.

Quadrant K in FIG. 8 shows the ICD 12 rotated 20 degrees down, while quadrant L shows the ICD 12 rotated 20 degrees up. Quadrant M in FIG. 8 shows the ICD 12 rotated 20 degrees to the right and quadrant N shows the ICD 12 rotated 20 degrees up and to the right.

The image modification means 31 of the invention may be on-board the camera 10 as shown in FIG. 7, or at some other location, but may include electronics for the aspect ratio selection means (FIGS. 1 and 3), the means that achieves the frame selection or cropping and masking effect (FIG. 2) in conjunction with the inclinometer 26, the controller for the yoke pivoting (FIGS. 5, 6 and 8) whether used for creating the focus landscape, or, with the inclinometer, to correct or modify the digital image for convergence, or for focus according to the Scheimpflug Rule, or for modifying the high resolution image file to create any other form of the modified digital image.

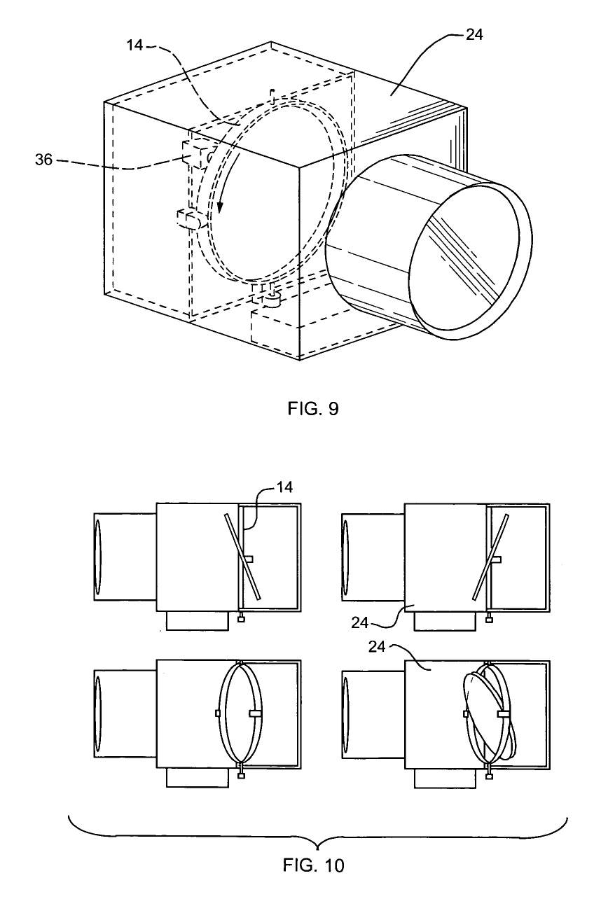

In FIGS. 9 and 10 the digital camera body 24 contains a yoke 14 that comprises an inner yoke hoop that carries the ICD and which is mounted for pivotal motion to an outer yoke hoop. As shown in FIG. 10, upper left quadrant, the inner hoop can be driven by a first digital drive motor with respect to the outer hoop to pivot the ICD about a horizontal axis, e.g. about 20 degrees counterclockwise, or in the upper right quadrant, 20 degrees clockwise. For pivoting about a vertical axis, the outer hoop is drive by a second motor mounted to the camera housing 24, e.g. 20 degrees to one side as shown in the lower left quadrant, or both motors can be operated to tilt or pivot the ICD to one side and counterclockwise as shown in the lower right quadrant.

FIG. 9 also illustrates another embodiment of the invention which includes a further digital motor 36 that is capable of rotating the ICD around in the inner loop in the direction of the curved arrow and within the plane of the ICD. In this way a standard rectangular ICD mounted in the yoke can be rotation 90 degrees in either direction between horizontal and vertical aspect ratio images, without rotating the camera body (for a total of up to 180 degrees). This alternate aspect ratio selection means can be used alone or in combination with the other features of the invention such as the tilting yoke features, to produce a digital camera with advanced features but with a more conventionally shaped ICD. The rotation of the ICD can also be used to compensate for roll as discussed above so that rotation of up to 90 or 180 degrees is possible.

While a specific embodiment of the invention has been shown and described in detail to illustrate the application of the principles of the invention, it will be understood that the invention may be embodied otherwise without departing from such principles.

What is claimed is:

1. A digital camera comprising:
a housing;
an image capture device in the housing, the image capture device having a selected shape with a flat light sensing surface laying in an image capture plane of the image capture device, the selected shape being one of: circular, oval, polygon with at least about eight sides and cross-shaped, so that the light sensing surface covers more area than that of a modified digital image to be created using the image capture device;
a lens having a lens plane and being connected to the housing for directing light from an actual image plane outside the housing, onto the light sensing surface;
electronic means connected to the image capture device for capturing image data from the image capture device corresponding to the light from the actual image to create a high resolution image file;
memory means connected to the electronic means for storing the high resolution image file; and
image modification means connected to the memory for modifying the high resolution image file to create the modified digital image.

2. A digital camera according to claim 1, wherein the selected shape is circular.

3. A digital camera according to claim 1, wherein the selected shape is cross-shaped.

4. A digital camera according to claim 1, wherein the selected shape is oval.

5. A digital camera according to claim 1, wherein the selected shape is polygonal with at least about eight sides.

6. A digital camera according to claim 1, including an inclinometer in the housing for detecting an inclination angle of the housing about at least one horizontal axis, the inclinometer being connected to the image modification means for correcting at least one feature of the high resolution image file for creating the modified digital image.

7. A digital camera according to claim 1, including an inclinometer in the housing for detecting at least a roll inclination angle of the housing about a horizontal axis extending through the image capture device and the lens, the inclinometer being connected to the image modification means for correcting the high resolution image file for roll of the housing to create the modified digital image.

8. A digital camera according to claim 1, including yoke means in the housing for mounting the image capture device for pivoting about at least one axis passing through the image capture plane, with respect to the housing.

9. A digital camera according to claim 1, wherein the image modification means comprises aspect ratio control means connected to the memory means for modifying the high resolution image file to create the modified digital image to cover only a selected reduced area of the light sensing surface having one of a plurality of aspect ratios and for masking a remaining area of the light sensing surface.

10. A digital camera according to claim 1, including a viewfinder connected to the electronic means and to the image modification means for displaying digital images corresponding to modified and unmodified versions of the high resolution image file.

11. A digital camera according to claim 1, including at least one of a pitch and roll yoke in the housing for mounting the image capture device and focus plane control means for controlling at least one of the pitch and roll of the image capture device with respect to the housing and the actual image plane to correct the modified digital image for focus.

12. A digital camera according to claim 1, including at least one of pitch and roll yoke in the housing for mounting the image capture device, the image modification means comprising digital convergence correction means connected to the electronic means for correcting the digital image for convergences based on at least one of a pitch and a roll of the image capture device with respect to the housing.

13. A digital camera according to claim 1, including distance sensing means connected to the electronic means for determining a distance between the lens and a selected point on the actual image plane.

14. A digital camera according to claim 1, including a distance sensing means connected to the electronic means for creating focus readings, and yoke means in the housing for mounting the image capture device for pivoting about at least one axis passing through the image capture plane with respect to the housing, the image modification means operating the yoke means to pivot the image capture device to a plurality of positions corresponding to a plurality of focus points in the actual image plane and to take a focus reading at each focus point to create a focus point landscape and, using the landscape to pivot the image capture device to a position corresponding to an optimum focus for the actual image plane.

15. A digital camera comprising:
a housing;
an image capture device in the housing, the image capture device having a flat light sensing surface laying in an image capture device plane which is shaped to encompass a plurality of different aspect ratios;
a lens connected to the housing for directing light from an actual image plane outside the housing, onto the light sensing surface of the image capture device;
electronic means connected to the image capture device for capturing image data from the image capture device corresponding to the light from the actual image to create a digital image; and
memory means connected to the electronic means for storing the image data.

16. A digital camera according to claim 15, including an inclinometer in the housing for detecting an inclination angle of the housing about at least one horizontal axis.

17. A digital camera according to claim 15, including an inclinometer in the housing for detecting at least a roll inclination angle of the housing about a horizontal axis extending through the image capture device and the lens.

18. A digital camera according to claim 15, including yoke means in the housing for mounting the image capture device for pivoting about at least one axis passing through the image capture plane.

19. A digital camera according to claim 15, including aspect ratio control means connected to the memory means for modifying the image data to create a modified digital image to cover only a selected reduced area of the light sensing surface having one of a plurality of aspect ratios and for masking a remaining area of the light sensing surface.

20. A digital camera according to claim 15, including a viewfinder connected to the electronic means and means for displaying digital images corresponding to modified and unmodified versions of the image data.

21. A digital camera according to claim 15, including at least one of a pitch and roll yoke in the housing for mounting the image capture device and focus plane control means for controlling at least one of the pitch and roll of the image capture device with respect to the housing and the actual image plane to correct a position of the image capture device for focusing of the actual image plane.

22. A digital camera according to claim 15, including at least one of pitch and roll yoke in the housing for mounting the image capture device, image modification means comprising digital convergence correction means connected to the electronic means for correcting the image data for convergences based on at least one of a pitch and a roll of the image capture device with respect to the housing.

23. A digital camera according to claim 15, including distance sensing means connected to the electronic means for determining a distance between the lens and a selected point on the actual image plane.

24. A digital camera according to claim 15, including distance sensing means connected to the electronic means for creating focus readings, and yoke means in the housing for mounting the image capture device for pivoting about at least one axis passing through the image capture plane with respect to the housing, and image modification means operating the yoke means to pivot the image capture device to a plurality of positions corresponding to a plurality of focus points in the actual image plane and to take a focus reading at each focus point to create a focus point landscape and, using the landscape to pivot the image capture device to a position corresponding to an optimum focus for the actual image plane.

25. A digital camera comprising:
a housing;
an image capture device in the housing, the image capture device having a flat light sensing surface laying in an image capture device plane;
a lens at a lens plane and connected to the housing for directing light from an actual image plane outside the housing, onto the light sensing surface of the image capture device;
electronic means connected to the image capture device for capturing image data from the image capture device corresponding to the light from the actual image to create a digital image;
memory means connected to the electronic means for storing the image data;
yoke means in the housing for mounting the image capture device for pivoting about at least one axis passing through the image capture plane; and
drive means connected to the yoke means for pivoting the image capture device with respect to the lens plane and the actual image plane so that the actual image plane, the image capture device plane and the actual image plane intersect along a line.

26. A digital camera according to claim 25, including image modification means connected to the memory for modifying the image data to create a modified digital image which compensates for perspective distortion of the actual image as viewed through the lens.

27. A digital camera according to claim 25, including an inclinometer in the housing for detecting an inclination angle of the housing about at least one horizontal axis.

28. A digital camera according to claim 25, including aspect ratio control means connected to the memory means for modifying the image data to create a modified digital image to cover only a selected reduced area of the light sensing surface having one of a plurality of aspect ratios and for masking a remaining area of the light sensing surface.

29. A digital camera according to claim 25, including a viewfinder connected to the electronic means and means for displaying digital images corresponding to modified and unmodified versions of the image data.

30. A digital camera according to claim 25, including at least one of a pitch and roll yoke in the housing for mounting the image capture device and focus plane control means for controlling at least one of the pitch and roll of the image capture device with respect to the housing and the actual image plane to correct a position of the image capture device for focusing of the actual image plane.

31. A digital camera according to claim 25, wherein the light sensing surface of the image capture device is circular.

32. A digital camera according to claim 25, wherein the light sensing surface of the image capture device is cross-shaped.

33. A digital camera according to claim 25, wherein the light sensing surface of the image capture device is oval.

34. A digital camera according to claim 25, wherein the light sensing surface of the image capture device is polygonal with at least eight sides.

35. A digital camera comprising:
a housing;
a rectangular image capture device in the housing, the image capture device having a flat light sensing surface laying in an image capture device plane;
a lens at a lens plane and connected to the housing for directing light from an actual image plane outside the housing, onto the light sensing surface of the image capture device;
electronic means connected to the image capture device for capturing image data from the image capture device corresponding to the light from the actual image to create a digital image;
memory means connected to the electronic means for storing the image data;
aspect ratio selection means for mounting the image capture device to the housing for rotating the image capture device within its plane and to at least two different positions corresponding to two different aspect ratios; and
drive means connected to the aspect ratio selection means for rotating the image capture device to the at least two different positions corresponding to the two different aspect ratios.

36. A digital camera according to claim 35, including image modification means connected to the memory for modifying the image data to create a modified digital image which compensates for perspective distortion of the actual image as viewed through the lens.

37. A digital camera according to claim 35, including an inclinometer in the housing for detecting an inclination angle of the housing about at least one horizontal axis.

38. A digital camera according to claim 35, wherein the aspect ratio selection means and drive means rotate the image capture device by up to 90 degrees in the housing.

39. A digital camera according to claim 35, including a viewfinder connected to the electronic means and means for displaying digital images corresponding to modified and unmodified versions of the image data.

40. A digital camera according to claim 35, including at least one of a pitch and roll yoke in the housing for mounting the image capture device and focus plane control means for controlling at least one of the pitch and roll of the image capture device with respect to the housing and the actual image plane to correct a position of the image capture device for focusing of the actual image plane.
